(19) United States
(12) Patent Application Publication
(10) Pub. No.: US 2009/0279434 A1
(43) Pub. Date: Nov. 12, 2009

(54) Packet-Switched Access Networks

(76) Inventors: Abdol Hamid Aghvami, London (GB); Paul Anthony Pangalos, London (GB); Dev Pragad Audsin, London (GB)

Correspondence Address: LEWIS, RICE & FINGERSH, LC;ATTN: BOX IP DEPT., 500 NORTH BROADWAY, SUITE 2000, ST LOUIS, MO, 63102, US

(21) Appl. No.: 12/337,213

(22) Filed: Dec. 17, 2008

(30) Foreign Application Priority Data
Dec. 24, 2007 (GB) 07 251 43.2

(51) Int. Cl. H04L 12/56; H04L 12/26

(52) U.S. Cl. 370/235

(57) ABSTRACT

In a packet-switched access network using a tunnelling-type micro-mobility protocol whereby packets are caused to flow through at least one mobility agent located in said access network, a method of reducing congestion at and/or in routers near said mobility agent, which method comprises the steps of causing packet traffic of a first class to use said tunnelling-type micro mobility protocol and packet traffic of a second class to use another mobility protocol, whereby packet traffic of said second class is routed across said access network away from said mobility agent.

### CROSS REFERENCE TO RELATED APPLICATION(S)

This application claims foreign priority to United Kingdom Patent Application Serial Number 07 251 43.2 filed Dec. 24, 2007, the entire disclosure of which is herein incorporated by reference.

### BACKGROUND OF THE INVENTION

1. Field of the Invention

The present invention relates to a method of reducing congestion at and/or in routers near a mobility agent in a packet-switched access network, to a method of operating a mobile node, to a method of operating a network node, to a packet-switched wireless access network for performing the method, to a mobile node for use in the method, to a method of manufacturing such a mobile node, and to a tunnelling type micro-mobility protocol message for use in a method as aforesaid.

2. Description of Related Art

Mobility at the network layer is concerned with maintaining the routability of packet data to and from a mobile node when that mobile node moves away from its home access network. There are two main types: macro-mobility protocols and micro-mobility protocols. The main macro mobility candidate for provision of this functionality is Mobile IP (MIP). Very briefly MIP relies on a Home Agent in the home access network to tunnel IP packets to the domain where the mobile node is attached. The mobile node forms a Care-of Address (CoA) that is globally topologically correct in the network to which it is attached. The Home Agent encapsulates packets that it receives addressed to the mobile node's home address in another IP packet addressed to the CoA. In this way packet data may still reach the mobile node even when it is away from the home network. Further details of Mobile IP can be found in RFC 3344, 3775 and 3776 to which reference is specifically made.

However, when a mobile node hands over to a new access router, binding updates are triggered to the Home Agent, etc. These binding updates can introduce unwanted delays and loss of packets, and thereby degradation in performance from the user's perspective. When attached to a particular wireless access network (such as a cellular network), a mobile node may change its point of attachment (i.e. access router) quite frequently (e.g. every few minutes or more often, particularly if on the move). Each change triggers configuration of a new CoA, followed by the necessary binding updates. Doing this frequently (e.g. every few minutes) is not practical.

Hierarchical Mobile IPv6 (HMIPv6) has been proposed (see RFC 4140) to address this problem. HMIPv6 provides a mobility agent known as a Mobility Anchor Point (MAP) in the access network. A MAP is a logical entity that handles micro-mobility for the mobile node Micro-mobility is a change in point of attachment of the mobile node from one access router to another, both of which are within the same domain of the access network. Whenever this happens, the mobile node sends a binding update to the MAP (comprising a new Link local CoA or LCoA), but the mobile node's primary CoA (or Regional CoA or RCoA) remains unchanged. In this way the mobile node can move between access routers in the same administrative domain without having to send a binding update to the Home Agent. In contrast when the mobile node changes point of attachment to an access router in a different access network, this is a macro-mobility event i.e. requiring a binding update to be sent to the Home Agent of the mobile node.

Another micro-mobility protocol presently under development by the IETF to address similar problems is Proxy Mobile IP (v4 or v6) or ‘PMIP’. The latest Internet-Draft is draft-ietf-netlmm-proxymip6-07.txt (presently available at www.ietf.org/internet-drafts/draft-ietf-netlmm-proxymip6-07.txt) and is incorporated fully herein for all purposes. The essential difference between HMIP and PMIP is that in the latter the network is responsible for managing mobility on behalf of the mobile node, without requiring the mobile node to participate in any mobility-related signalling.

In tunnelling type micro-mobility protocols such as Hierarchical Mobile IPv6 (HMIPv6), Proxy Mobile IPv6 (PMIP), BRAIN Candidate Mobility Protocol (BCMP)), a bi-directional tunnel is established between each mobile node (or an access router in the case of PMIP) and its associated mobility agent (also known as Mobility Anchor Point (MAP) in HMIPv6 and as a Local Mobility Anchor (LMA) in PMIP). All packets sent from and to Mobile Nodes flow through this bi-directional tunnel and pass through the router where the mobility agent resides. The main advantage of using HMIPv6 (or similar) is that handover latency of Mobile IP (or other macro-mobility protocol) can be reduced since mobile nodes do not have to send binding updates to the Home Agent and correspondent nodes following a handover in the domain of the MAP Reduction in such latency can be particularly important for delay sensitive packets carrying voice data for example, and the goal of creating all-IP cellular networks is dependent on achieving fast handovers at the network layer.

However, whilst tunnelling-type micro-mobility protocols address the handover latency problem, we have realised that the use of a bi-directional tunnel is very likely to increase packet delay in the access network itself. In particular, all packets must pass through the mobility agent and therefore the routing across the access network is broken into two sections: gateway to MAP, and MAP to mobile node (and vice-versa). This results in packet congestion around the MAPs leading to bottlenecks within the access network. When tunnelling-type micro-mobility is not used in the access network, packets can be routed through the best path to and from the gateway, which is not necessarily via a MAP.

Much research has been performed to implement QoS routing in packet-switched networks. For example, protocols such as DiffServ allow different QoS to be provided for different packet traffic classes. The primary objective of QoS routing is to find the best path with the least congestion taking into consideration the QoS resources in each link. This overcomes the disadvantage of shortest path routing where the certain shortest paths are quickly congested, resulting in lower network capacity. Hence QoS routing increases the network capacity by routing the packets to avoid the congested paths even if it is the shortest path.

However, since tunnelling-type micro-mobility protocols breaking the routing across the access network in two, under utilized paths are created within the network which cannot be used; this reduces the capacity of the access network. Furthermore any potential benefits of using QoS routing in such a network may not be fully realised.

Such delays can be particularly detrimental to delay sensitive packet traffic (carrying real-time data such as voice for example). Therefore it is important to reduce these delays if possible so delay sensitive traffic can be routed to mobile nodes over packet-switched networks.

Further details of the problem can be found in “The Impact of Mobility Agent based Micro Mobility on the Capacity of Wireless Access Networks”, Audsin, D. P. Friderikos, V, Pangalos, P. A and Aghvami, A H., IEEE GLOBECOM 2007, 26-30 Nov. 2007, Washington, D.C., USA. Reference is specifically made to that document and it is incorporated fully herein for all purposes.

### SUMMARY OF THE INVENTION

According to the present invention there is provided in a packet-switched access network using a tunnelling-type micro-mobility protocol whereby packets are caused to flow through at least one mobility agent located in said access network, a method of reducing congestion at and/or in routers near said mobility agent, which method comprises the steps of causing packet traffic of a first traffic class to use said tunnelling-type mobility protocol and packet traffic of a second traffic class to use another mobility protocol, whereby packet traffic of said second traffic class is routed across said access network away from said mobility agent. The first and second classes may be assigned on a QoS basis, for example the first class may be delay sensitive traffic (such as voice traffic) and the second class may be relatively more delay tolerant than the first class (such as web-browsing traffic). This has the advantage that less delay tolerant traffic may use the tunnelling-type mobility protocol, whilst the more delay tolerant traffic is routed around the mobility agent, reducing congestion at or in routers around the mobility agent. The packet-switched access network may be of the ‘wireless last hop’ type, where access routers of the network provide wireless access for mobile nodes to wired network infrastructure.

The tunnelling-type micro-mobility protocol may be of the network-based mobility type, such as Proxy Mobile IPv6, or it may be Hierarchical Mobile IPv6, or any functionally similar mobility protocol that uses a tunnel and mobility agent within the access network. The other mobility protocol may be a macro-mobility protocol of the end-to-end type (such as SIP) or of the tunnelling type (such as Mobile IP), or may be a micro mobility protocol such as a host based type (such as Cellular IP and Hawaii) or a tunnelling type (such as HMIPv6 and PMIP). For example SIP could be used to send a REINVITE message with the same session_id to a correspondent node. The REINVITE message may involve change of IP address caused by movement of the mobile node. In conjunction with TCP migrate (see nms.csail.mit.edu/talks/e2e-migrate.pdf) SIP can be used to provide an end-to-end mobility solution.

Preferably, the method further comprises the step of said access network advertising to mobile nodes which class of packet traffic may use which mobility protocol. In one aspect, mobile nodes might be pre-configured (e.g. at point of manufacture of via an OTA update) to use different mobility protocols for different traffic classes. However, by advertising to mobile nodes which mobility protocol is available for which class of traffic, the access network can change the availability as desired. One example might be to change availability according to time of day for example to reflect daily traffic patterns. A further advantage of this arrangement is that mobile nodes are flexible to meet different QoS requirements from different access networks.

Advantageously, the method further comprises the step of advertising to mobile nodes a static mapping between traffic class and mobility protocol. Some access networks may prefer to fix which mobility protocol is used by which type of traffic; this might be to reduce the signalling overhead on the network for example. Improvements in network throughput (i.e. reduced congestion) can be realised with such a static mapping. One example of such a static mapping is to map all voice traffic to the tunnelling-type micro-mobility protocol and all other traffic to another mobility protocol such as Mobile IP.

Preferably, the method further comprises the step of advertising to mobile nodes a dynamic mapping between traffic class and mobility protocol. One advantage of this is that the access network has greater control over the use by mobile nodes of the tunnelling-type micro-mobility protocol, and in particular can restrict that use as the access network becomes congested, and/or as the mobility agent and/or routers around the mobility agent become congested.

Advantageously, said dynamic mapping comprises the step of changing which traffic class is mapped to which mobility protocol. In this way the access network may control which types of traffic receive the advantages of the tunnelling-type mobility protocol.

Preferably, the method further comprises the step of monitoring packet congestion within said access network, and changing said dynamic mapping between traffic class and mobility protocol according to said packet congestion. Congestion data may be passed around the network using SNMP or similar. In one embodiment congestion is monitored and when a certain minimum threshold is crossed, the dynamic mapping can be changed to reduce the congestion. The minimum threshold may be the transition point where the network changes from being under-utilised to over-utilised. Alternatively the network operator may set the minimum threshold according to the particular network characteristics.

Advantageously, the method further comprises the step of expressing said packet congestion as a value on a scale between minimum and maximum values, and using said value to adjust a traffic class threshold for setting which traffic classes use said tunnelling-type micro-mobility protocol, and which traffic class(es) use said other mobility protocol. In one embodiment the packet congestion value is represented by λ, the total number of traffic classes in the network by K and a threshold M is set to divide the classes according to M=round(λ*K), where round( ) is a function that rounds the value of M up or down to the nearest integer.

In one embodiment a Bandwidth Broker monitors packet congestion.

In another embodiment said mobility agent monitors packet congestion. In another aspect the Bandwidth Broker and mobility agent may be responsible for monitoring packet congestion at different times in the same network.

Preferably, the method further comprises the step of, as congestion increases in said access network, reducing the number of traffic classes that can use said mobility agent, whereby said mobile nodes are caused to use said other mobility protocol to send and receive packet data for an increased number of traffic classes. By reducing the number of traffic classes that can use the tunnelling-type micro-mobility protocol the number of packets that the mobility agent has to handle can be reduced. One effect of this is that congestion can be relieved.

Advantageously, the step of reducing the number of traffic classes comprises assigning relatively delay tolerant traffic classes to said other mobility protocol, whereby relatively less delay tolerant traffic class(es) remain in said reduced number of traffic classes able to use said tunnelling-type micro-mobility protocol. One advantage of this is that congestion in the access network can be reduced, whilst those services (e.g. real-time) that are delay intolerant can continue receive the advantages provided by the tunnelling-type mobility protocol.

Preferably, the method further comprises the step of advertising to said mobile nodes which other mobility protocol(s) is available for said packet data of said increased number of traffic classes.

Advantageously, the method further comprises the step of, as congestion decreases in said access network, increasing the number of traffic classes that can use said mobility agent, whereby said mobile nodes are caused to use said other mobility protocol to send and receive packet data for a decreased number of traffic classes. In this way, the access network can respond dynamically to changes in congestion so that, when conditions permit, more traffic can obtain the advantages offered by the tunnelling-type micro-mobility protocol.

Preferably the method further comprises the step of advertising to said mobile nodes which other mobility protocol(s) is available for said packet data of said decreased number of traffic classes.

Advantageously, said advertising step comprises using a field in an advertisement message, receipt of said field indicating to each mobile node which mobility protocol is available for which class of traffic.

Preferably, said field comprises bits for representing an identity of a traffic class, and bits for representing an identity of a mobility protocol to be used by a mobile node sending packet data in said traffic class.

Advantageously, said field is part of an MAP option message to form an extended MAP option, the method further comprising the steps of said access network composing and advertising said extended MAP option to mobile nodes. Such advertisement may be done directly, although it is preferred that it is done indirectly via access routers in the domain of the mobility agent.

The access network method steps above may be performed by mobility agent on a router in the access network. The combination of such a router and the mobility agent called a Mobility Anchor Point (MAP) in HMIP terminology, or a Local Mobility Anchor (LMA) in PMIP terminology.

According to another aspect of the present invention there is provided a method of operating a mobile node for accessing a packet-switched wireless access network, said mobile node capable of sending packet data of a plurality of different traffic classes across said access network, which method comprises the step of determining which traffic class is associated with an application intending to send packets across said access network, and depending on said traffic class as determined, using either a tunnelling-type micro-mobility protocol or another mobility protocol to send said packets to said access network. One advantage is that real-time services (e.g. voice) can take advantage of the tunnelling-type micro-mobility protocol, whereas more delay tolerant traffic (e.g. web browsing) can be routed around the mobility agent, thereby relieving congestion in the access network around the mobility agent by making use of under-utilised routing paths.

Preferably, said mobile node stores a direct or indirect mapping between application types and traffic classes, the method further comprising the step of using said mapping to determine said traffic class for said application. The indirect mapping may be via a mapping from application type to traffic class, and then from traffic class to mobility protocol.

Advantageously, said mapping is static whereby said mobile node uses the same mapping for any access network that is uses.

Preferably, said mapping is dynamic. In this way the mobile node may be re-configured so that applications may be caused to use different mobility protocols at different times.

Advantageously, the method further comprises the steps of receiving an advertisement message from said access network, and examining said advertisement message to determine if it comprises an adjustment to said mapping, and if so, adjusting said mapping. Following receipt of the advertisement message the mobile node may remain using the tunnelling-type micro-mobility protocol for ongoing sessions. However for any new sessions that are started the mobile node must follow the new traffic class/mobility mapping and therefore traffic from the same application (but different session) will be routed using the other mobility protocol. In this way a very quick response can be made to congestion in the network.

Preferably, said advertisement message comprises a field having bits for representing an identity of a traffic class, and bits for representing an identity of a mobility protocol to be used by said mobile node when sending packet data in that traffic class, wherein said adjustment step comprises storing said field in memory.

Advantageously, the method further comprises the steps of triggering said determination upon opening of a socket by said application.

Preferably, said step of determining which traffic class is associated with said application comprises examining a destination port number to be used in transport layer segments.

Advantageously, the method further comprises the step of using said destination port number to lookup which mobility protocol is to be used for that type of packet data.

Preferably, said step of looking up said mobility protocol comprises using said port number to lookup a traffic class associated therewith, using said traffic class to lookup said mobility protocol.

Advantageously, the other mobility protocol comprises a macro-mobility protocol or a micro-mobility protocol. Such a protocol may be a host based micro-mobility protocol (e.g. Cellular IP, Hawaii) or a macro-mobility protocol such as Mobile IP. The other mobility protocol may be a macro-mobility protocol of the end-to-end type (such as SIP) or of the tunnelling type (such as Mobile IP), or may be a micro mobility protocol such as a host based type (such as Cellular IP and Hawaii) or a tunnelling type (such as HMIPv6 and PMIP).

Additionally or alternatively the other mobility protocol may comprise a non-mobility agent based mobility protocol.

According to another aspect of the present invention there is provided a method of operating a network node in a packet-switched wireless access network, which method comprises performing the mobile node steps as set out above. In one aspect the network node is an access router. In this way the invention can be used in a protocol such as PMIP where the functionality usually performed by a mobile node is performed by a network node (e.g. Mobility Access Gateway) in the access network. One advantage of this is that mobile nodes do not have to be re-configured to obtain the advantages of the invention.

According yet another aspect of the present invention there is provided a packet-switched wireless access network configured to perform the access network method steps set out above. The packet-switched access network may be an all-IP cellular network, an all-IP based core network using any type of Radio Access Network (RAN) e.g. cellular, Wi-Fi, Femtocell, WiMax. The access network may utilise IPv4, IPv6 or a combination of the two.

According to another aspect of the present invention there is provided a mobile node comprising a memory storing computer executable instructions that when executed perform the mobile node method steps set out above. By way of example the mobile node may be a mobile or cellular telephone, a PDA, a hand-held games console, a digital media player, a laptop or notebook computer, or any combination of the aforesaid. In another aspect the mobile node may be a mobile router.

According to yet another aspect of the present invention there is provided a method of manufacturing a mobile node, which method comprises the steps of storing in a memory of said mobile node computer executable instructions that when executed perform the mobile node method steps set out above.

According to another aspect of the present invention there is provided a tunnelling type micro-mobility protocol message comprising a field for identifying a traffic class mapped to a field for identifying a mobility protocol, receipt of said message causing network nodes to send packet data falling in said traffic class using said mobility protocol. The message may have a plurality of such fields, whereby network nodes may determine using the message which mobility protocol is to be used for which traffic class.

### BRIEF DESCRIPTION OF THE DRAWINGS

For a better understanding of how the invention may be put into practice, preferred embodiments of the invention applied in a heterogeneous network environment comprising three access networks will be described, by way of example only, with reference to the accompanying drawings, in which:

FIG. 1 is a schematic block diagram of a network environment comprising three access networks, each having the functionality of the invention and which provide access to the Internet or other IP backbone network for mobile nodes;

FIG. 2 is a schematic block diagram showing the general structure of an access network;

FIG. 3A is a schematic block diagram of computer hardware for storing and operating logical entities according to the present invention;

FIG. 3B is a schematic block diagram of a mobile node according to the present invention;

FIG. 4 is a schematic block diagram of an access network that was simulated to investigate how the positioning of MAPs affects packet congestion;

FIG. 5 is a graph of network throughput versus traffic demand in the access network of FIG. 4;

FIG. 6 is a graph of congestion at each of the intermediate routing nodes in the network of FIG. 4;

FIG. 7 is schematic block diagram of one of the access networks of FIG. 1 illustrating areas of packet congestion caused by MAPs;

FIG. 8 is a schematic flow diagram of steps in a method according to the present invention performed by an Enhanced Node;

FIG. 9 is a schematic diagram of an extended MAP option according to the present invention;

FIG. 10 is a schematic diagram showing a field according to the present invention that is part of the extended MAP option of FIG. 9;

FIG. 11 is a schematic diagram showing traffic classes may be divided according to the present invention;

FIG. 12 is a schematic diagram of steps in a method according to the present invention performed by a mobile node using an access network in FIG. 1; and

FIG. 13 is a graph of traffic demand versus network throughput comparing methods according to the invention with an access network using all HMIPv6.

### DESCRIPTION OF THE PREFERRED EMBODIMENT(S)

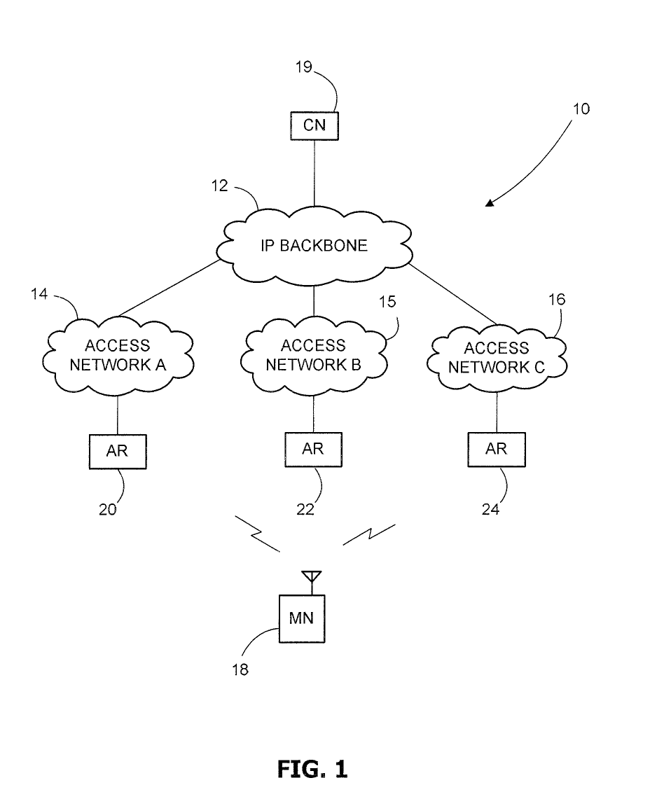

Referring to FIG. 1 an IP-based (IPv4 or IPv6 or a mixture thereof may be used in any of the networks mentioned herein) network environment generally identified by reference numeral 10 comprises an IP backbone 12 having a number of interconnected routers that provide access for network nodes to data and services stored on remote servers for example. As such the IP backbone 12 may form part of the Internet. In this embodiment any of three IP-based access networks 14, 15, 16 provide access for a wireless mobile node (MN) 18 to the IP backbone 12, although there may be any number of access networks and mobile nodes of course. The access networks 14, 15, 16 may be an IP-based cellular network (such as 3GPP Release 5 or 6, UMTS Long Term Evolution (LTE) or any future IP-enabled cellular network) or the combination of an ISP and a number of WLAN routers for example. Access to the IP backbone 12 enables the MN 14 to communicate with a correspondent node (CN) 19. The CN 19 may be a media server, a web server or another mobile node for example.

The MN 18 is physically separate from the access networks 14, 15, 16 but may communicate with one or more of them by means of a wireless link. Each access network 14, 15, 16 comprises an IP-enabled access router 20, 22, 24 that is a single hop (at the network layer) from the MN 18. Each access router 20, 22, 24 is connected to a wireless transceiver such as Node B or WLAN router for example.

Each access network 14, 15, 16 defines an administrative domain comprising a number of interconnected routers; therefore the domain is scoped so that at the edges of the network administration packets (such as link-state advertisements are dropped). Furthermore each access network 14, 15 and 16 and the MN 14 is able to operate Mobile IPv6 (MIPv6—see RFC 3775) and Hierarchical Mobile IPv6 (HMIPv6) as described in RFC 4140, or any functionally similar protocols. Both of these RFCs are fully incorporated herein by reference for all purposes. Thus each access network 14, 15, 16 comprises one or more router having the functionality of a mobility agent (or Mobility Anchor Point (MAP) in the terms of RFC 4140). The MAP is used by the MN 18 as a local Home Agent so that handovers between access routers in the same domain do not trigger a binding update to the Home Agent of the MN 18. The domain of each MAP is defined by the access routers that advertise the MAP information to attached MNs. As such there may be more than one MAP per access network.

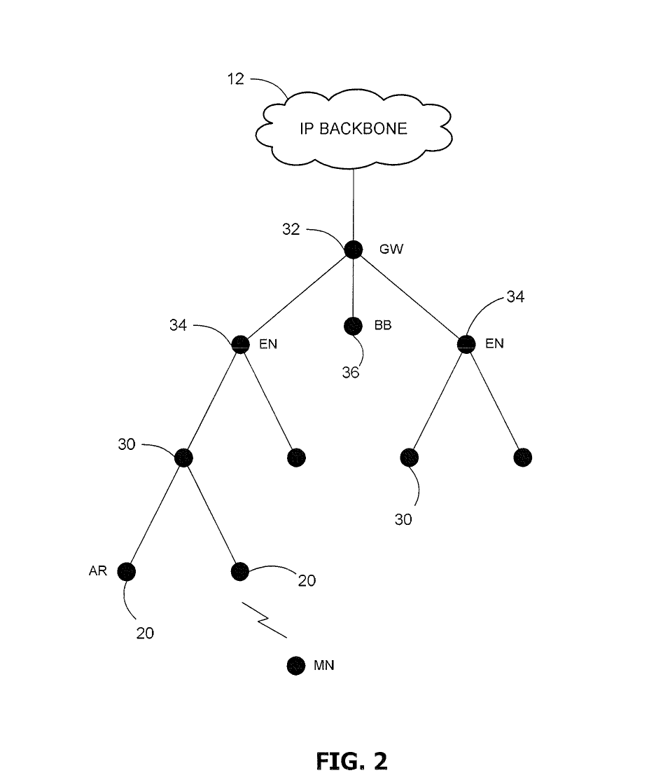

Referring to FIG. 2 the access network 14 comprises a number of interconnected routers 30. A gateway router (GW) 32 is the only entry and exit point of the access network 14 for packet traffic to and from the IP backbone 12 (although there may be other gateways). Two mobility agents hereinafter referred to as Enhanced Nodes (EN) 34 are each similar to a MAP as described in RFC 4140 but comprise the functionality described herein. It is possible for any of the access networks to have any number of ENs, each located at any point in the network.

Each router 30 is Diffserv-capable (see e.g. RFC 2475) and each operates an intra-domain link-state QoS routing algorithm, for example QoSPF as described in RFC 2676; that document describes an extension to the Open Shortest Path First (OSPF) routing algorithm. The extension enables distribution of QoS information (e.g. link state) amongst all routers in the domain of the access network 14 so that they can each maintain a database of network topology and determine accurate and consistent QoS routes. It is to be noted that it is not essential to the invention that the access network use a QoS routing protocol, such as QoSPF. The invention is not restricted to use with any particular kind of routing protocol, and therefore the access network may use best effort routing, etc.

The access network 14 also comprises a Bandwidth Broker (BB) 36. The BB 36 is a logical entity that is stored and executed on a network node within the domain. Further details of the architecture and function of Bandwidth Brokers can be found in RFC 2638 and in “A Discussion of Bandwidth Broker Requirements for Internet Qbone Deployment”, Neilson, R. et al., August 1999 to which reference is specifically made (the latter hereinafter referred to as Neilson). For example the BB 36 may function on the gateway GW 32 in the access network 14, or it may reside on a physically separate network node. The purpose of the BB 36 is to manage the QoS resources within a domain based on the Service Level Specifications (SLSs) that have been agreed in that domain (intra-domain communication), and to manage communication with other BBs in different domains (inter-domain communication). In this case, the BB 36 is responsible for the QoS resources in the access network 14. Given a specific QoS request by a user or other BB, a BB determines whether or not the requested QoS can be met by network nodes (usually routers) within the domain from one gateway in the domain to another. Each BB has access to the routing table of the network node on which it resides; accordingly by means of link state advertisement discussed in RFC 2676 it is aware of the QoS level (e.g. bandwidth) available over all links in its domain.

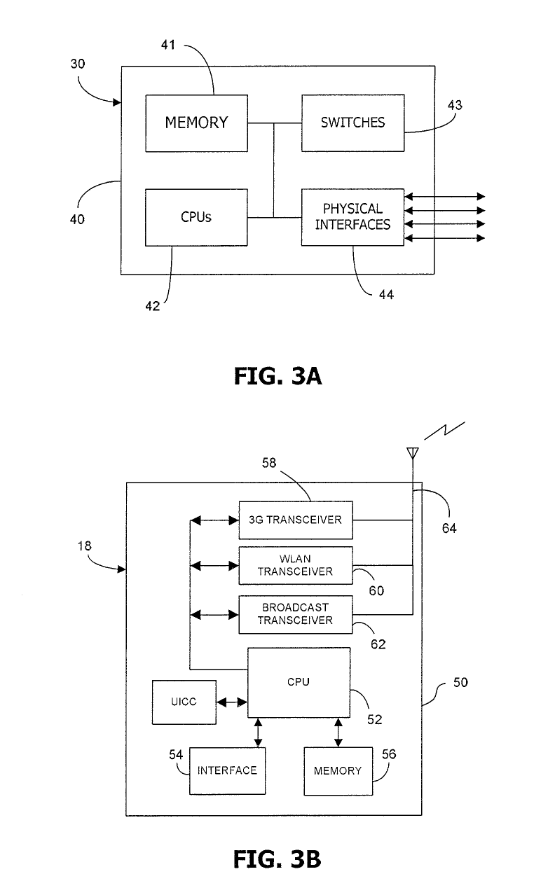

Referring to FIG. 3A one of the routers 30 comprises a housing 40, a memory 41, one or more CPU 42, switches 43 and physical interfaces 44. The physical interfaces 44 enable communication over a wired or wireless physical link with other routers 30 in the access network 14. The memory 41 may store computer executable instructions that when executed bring about the functionality of the various logical entities described herein, e.g. EN 34 and BB 36.

Referring to FIG. 3B the MN 18 comprises a case 50 housing a CPU 52, an interface 54, a computer memory 56, a 3G transceiver (or interface) 58, a WLAN transceiver (or interface) 60 and a broadcast transceiver (or interface) 62. The 3G transceiver 58 and the broadcast transceiver 62 are wired to an antenna 64 for reception and transmission of data with a mobile network and for reception of data from a broadcast network respectively. The WLAN transceiver 60 enables reception and transmission of data with wireless access points. The CPU 52 interfaces with all of the aforementioned components to process (store, access, etc.) electronic data. The memory 56 stores computer executable instructions that when executed by the CPU 44 perform the mobile node method steps as described herein. These computer executable instructions may be stored in the memory of the mobile during manufacture. It is to be noted that it is not essential for the mobile node to be multi-mode; the invention also has application for mobile nodes with only one interface, e.g. a cellular interface.

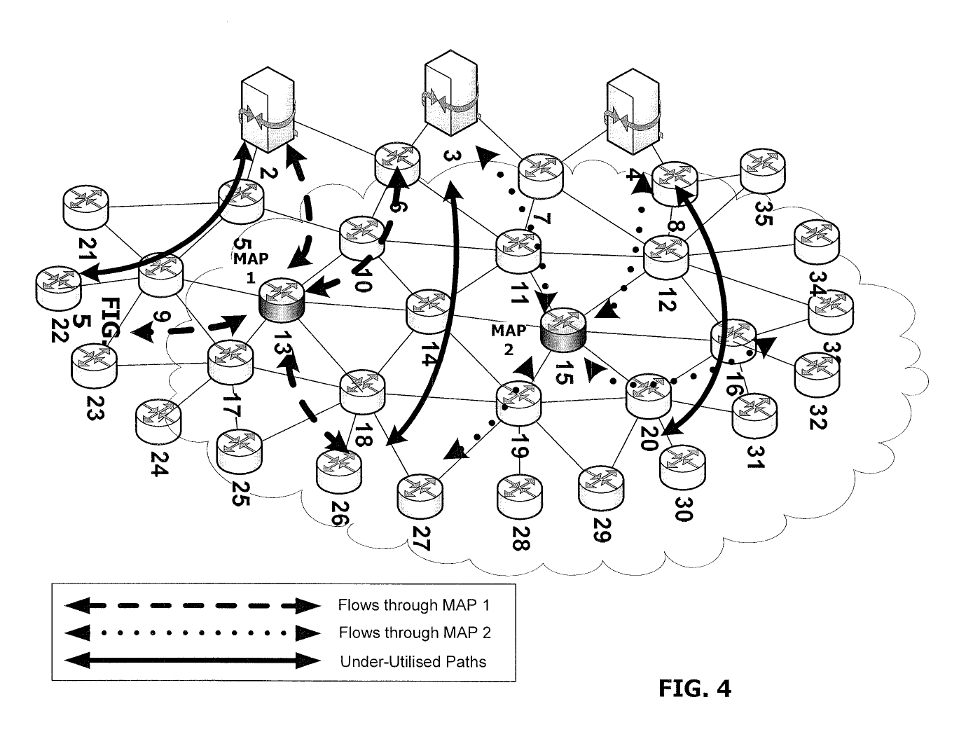

FIG. 4 shows a block diagram of an access network that was simulated in MATLAB to investigate the effect of mobility agent micro-mobility mechanisms on packet congestion in the access network. Each number shown directly below each network node in FIG. 4 is the number that was assigned to that network node for the purposes of the simulation. IP packets are assumed enter the access network through one of the gateways (numbered as 2, 3 and 4) from an imaginary source node of very high bandwidth. The IP packets are routed across the access network using generic QoS routing (which could be QoSPF) and reach a MN (not shown in FIG. 4) through the access router to which it is attached (access routers are numbered 21-35 in FIG. 4).

In the simulation, links were given capacities in units, where one unit can be any number of bps. The throughput of the network defined as total flow in the network (in bps) divided by total demand (in bps) placed on the network by the MNs, was scaled down by the maximum network throughput for all demands. This gives the throughput of the network relative to 1, where 1 represents throughput exactly matching demand. The throughput is greater than one when demand is less than the maximum that the network can support and therefore the network is under-utilised; whereas the throughput is less than 1 when the network cannot support the requested demand and therefore the network is over-utilised.

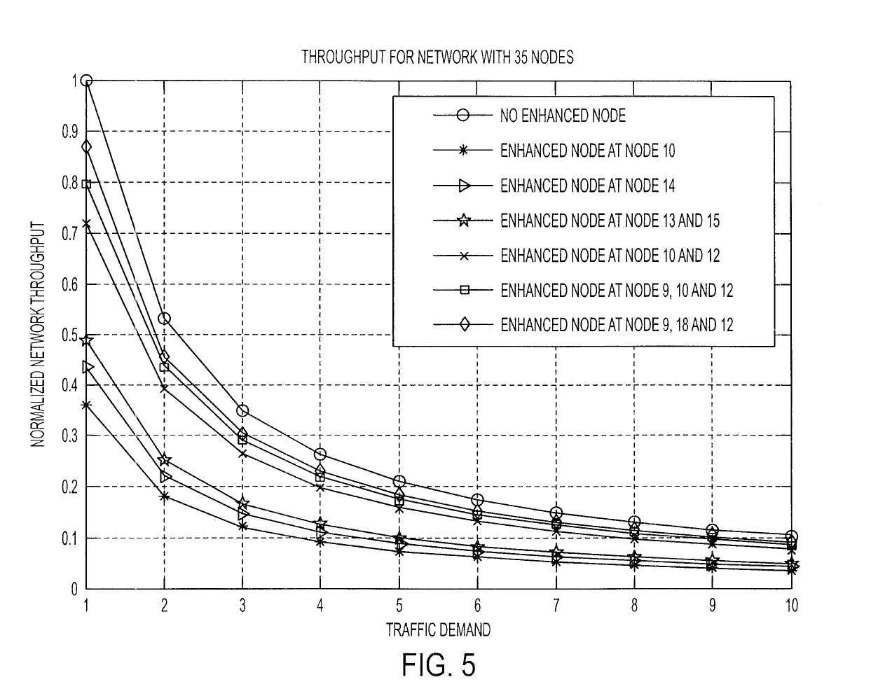

The simulation was used to investigate the throughput and congestion in the network. (i) in the absence of any tunnelling-type micro-mobility mechanism; and (ii) in the presence of one, two and three MAPs positioned arbitrarily in the topology. FIG. 5 shows the results from the simulation from which it can be seen that network throughput is reduced in scenario (ii) compared to scenario (i) for any traffic demand. Both increasing the number of MAPs and careful positioning of those MAPs in the network topology can improve throughput. However, further investigation revealed that simply increasing the number of MAPs does not necessarily improve throughput, since careful positioning of fewer MAPs was demonstrated to offer better throughput than random positioning of a greater number of MAPs.

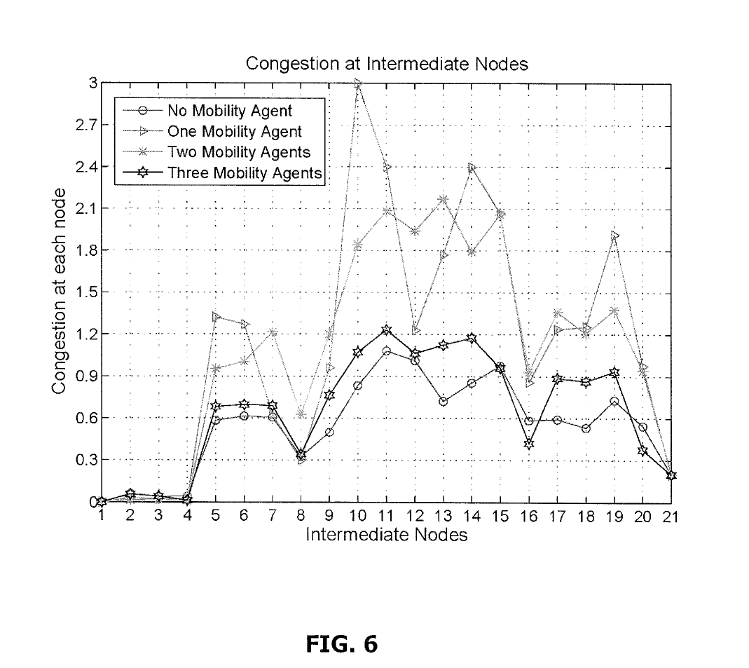

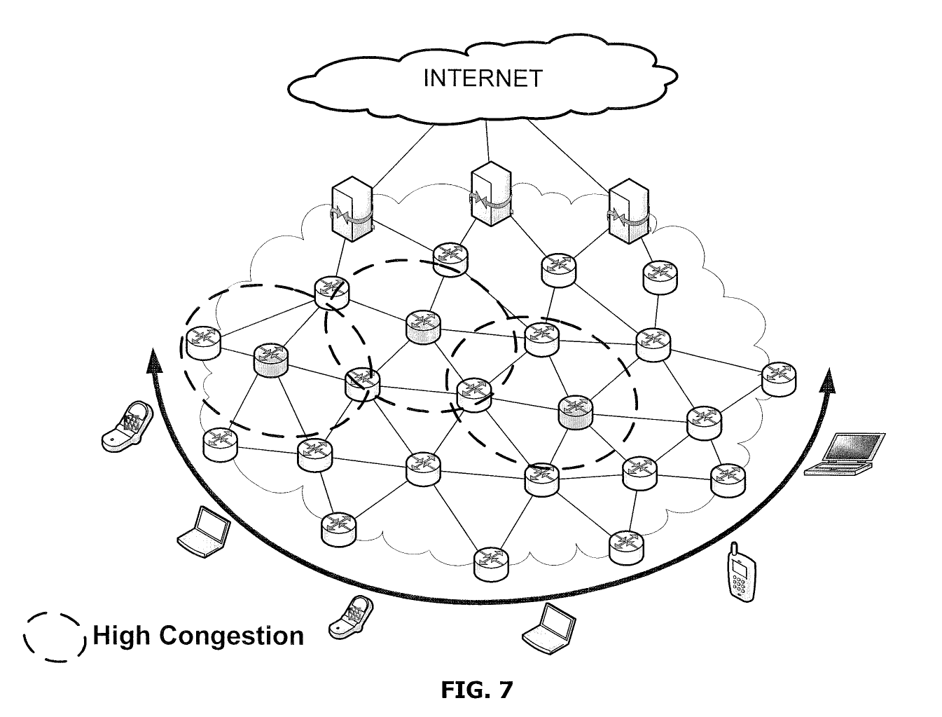

FIG. 6 shows how congestion varies at each router in the network. In the graph congestion is the ratio of bandwidth consumed by the flows at each node to the total bandwidth capacity available at each node. In the simulation using one mobility agent, the mobility agent was placed at node 10; the simulation of two mobility agents placed one at node 13 and the other at node 15; and the simulation of three mobility agents placed one at node 9, another at node 10 and the other at node 13. It can be seen that congestion is minimum when there are no MAPs in the network. When there is only one MAP (at node 10) congestion increases sharply around that node. Congestion drops progressively as more MAPs are added to the network. It can be seen that congestion bottlenecks appear around the or each MAP in the network, as illustrated in FIG. 7. This congestion around the or each MAP means that there are under-utilised routing paths in the network (see FIG. 4) and therefore that the capacity of the network is reduced. Accordingly, whilst tunnelling-type micro-mobility protocols offer advantages in terms of reducing delays caused by handovers using macro-mobility protocols (e.g. Mobile IP), the cost is reduced total capacity of the network.

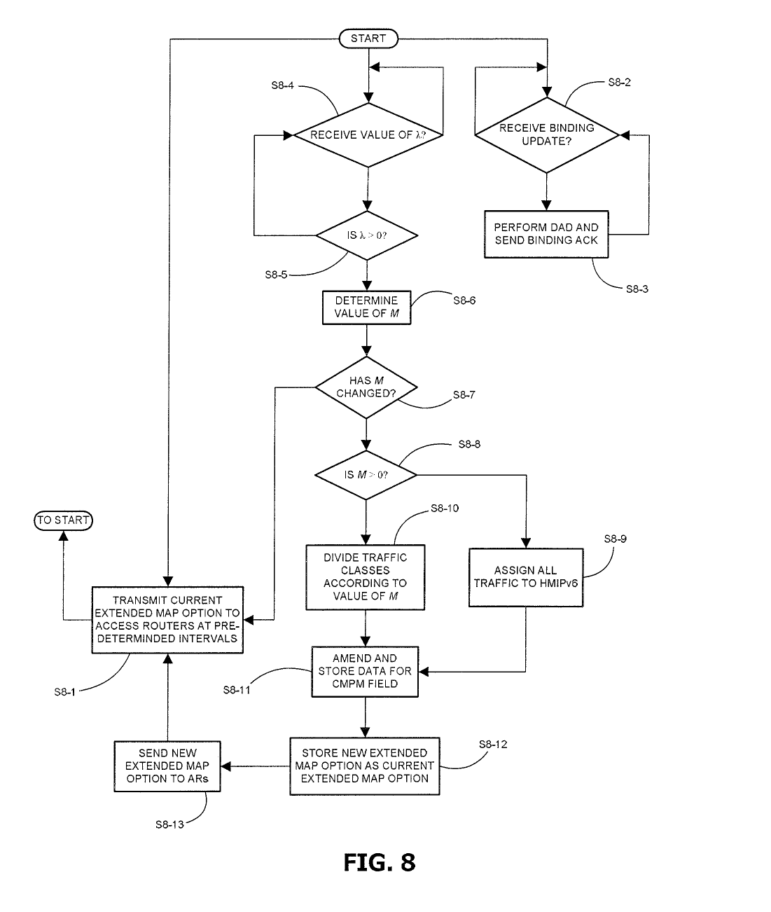

FIG. 8 shows steps in a method performed by an Enhanced Node according to the invention. When the mobile node 18 discovers an access network (such as the access network 14) for the first time it may take a decision to establish network layer connectivity with that network and create a binding at the EN 34. This may happen after the mobile node 18 is powered on, or during handover from another access network for example. However, it is not critical that the MN 18 does or does not have any ongoing sessions for it to decide to try to create a binding at the EN 34. In the following example, it is assumed that the MN 18 does not have any ongoing sessions during establishment of a binding.

Access routers (e.g. AR 20) in the access network 14 advertise their presence using Router Advertisements containing the MAP option (see RFC 4140 section 7). The MAP option contains inter alia a global IP address of the enhanced node 34 (i.e. a MAP enhanced with the functionality of the present invention) and the mobile node 18 uses this to auto-configure a Regional Care-of Address (RCoA) which is an address on the subnet of the enhanced node. The mobile node also auto-configures an On-link Care-of Address (LCoA) using the prefix advertised by the access router. The LCoA will be used to tunnel all packets between the mobile node 18 and the enhanced node 34, whereas the RCoA will be used for communication between the mobile node 18 and any other network node, such as a remote web server in the Internet.

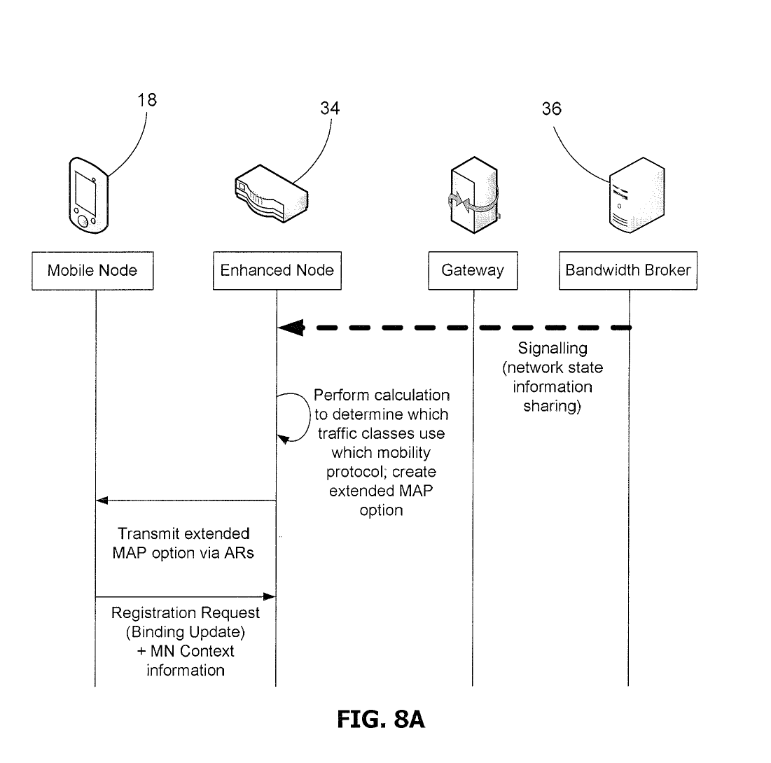

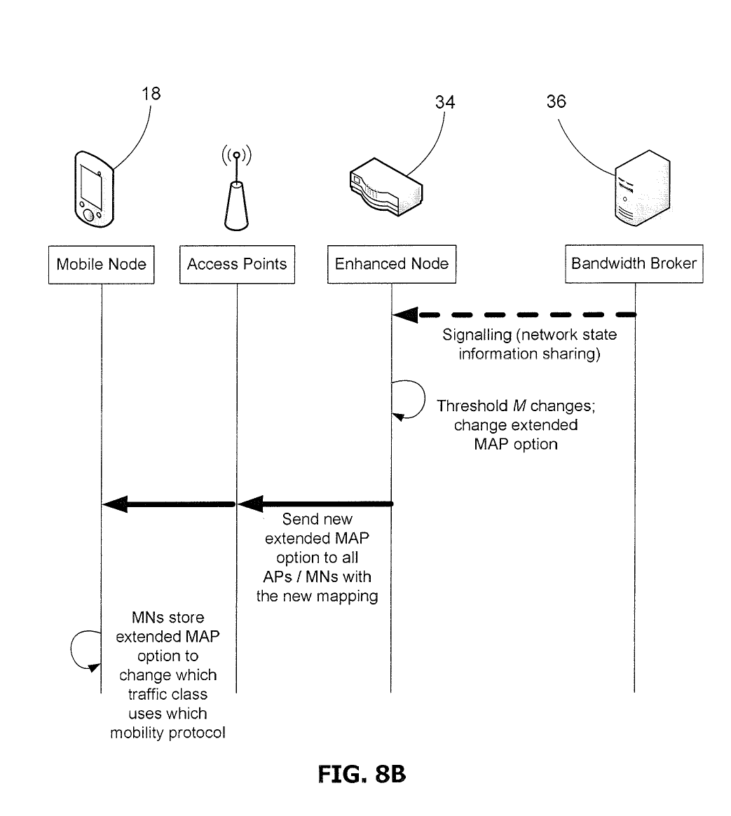

The EN 34 composes and transmits an extended MAP option for use by access routers in its MAP domain. FIG. 9 illustrates an extended MAP option 90 that is constructed and transmitted by the EN 34. The extended MAP option 90 comprises a MAP option part 92 that is in accordance with the MAP option described in RFC 4140, and a Class to Mobility Protocol Mapping (CMPM) field 94. The function of the CMPM field 94 is to advertise to MNs (either attached to the access network or wishing to attach to the access network) those classes of traffic that the EN 34 will handle under HMIPv6 and those classes of traffic that must be routed by another mobility protocol, such as Mobile IP. One way that the CMPM field 94 could be used to is to transmit a bit pattern that identifies the traffic class and the mobility protocol to which it is currently mapped by the EN 34. An example of such as bit pattern is shown in FIG. 10. The first six bits 96 of the CMPM field 94 are used to identify the traffic class and enable 26 traffic classes to be defined. The last two bits 98 are used to identify the mobility protocol to which the traffic class is currently mapped. Using two bits enables four mobility protocols to be identified by the CMPM field 94. Of course, it will be apparent that any number of bits can be used for the CMPM field 94 sufficient for the number of classes and mobility protocols used in any particular access network A generic formula for the size in bits of the CMPM field is. Size of field (No_class_bits+No_mobility_protocol_bits)*Total_no_of_traffic_classes where total_no_of_traffic_classes=2̂no_class_bits. The extended MAP option 90 carries enough such CMPM fields 94 to identify all traffic classes used in the access network 14

It will also be apparent the CMPM field could be constructed in various other ways. For example, the EN 34 could use a positive indication of traffic classes i.e. the CMPM field 94 contains only those traffic classes that are currently permitted to use HMIPv6 (the remaining classes being unable to use HMIPv6 by implication). Alternatively, the EN 34 could use a negative indication of traffic classes i.e. the CMPM field 94 contains those classes that are currently not permitted to use HMIPv6 (the remaining classes being able to use HMIPv6 by implication). Furthermore, if any access network only uses two mobility protocols (for example Mobile IP and HMIPv6), the mobility protocol bit(s) could be omitted altogether in the aforementioned positive and negative indication examples mentioned, provided that each MN is configured to interpret the extended MAP option correctly. Such configuration could be made by and OTA message for example or at point of manufacture.

As used herein the term ‘traffic class’ represents packets of data that require specific routing treatment in the access network. Furthermore each packet is identifiable as a packet that requires different processing. For example, the traffic classes mentioned herein can be classes of the DiffServ QoS architecture. Each of these classes can further include sub-classes within DiffServ. For example there can be four Assured Forwarding (AF) classes in the access network and each class can have three different drop probabilities (see www.cisco.com/en/US/products/ps6610/products_data_sheet09186a00800a3e30.html for example). Each AF traffic class/drop precedence combination can be treated as a unique traffic class that can be assigned to one or other mobility protocol. In another example the traffic class can correspond to a UMTS QoS class, as described in greater detail below.

Referring again to FIG. 8 the EN 34 starts three separate processes simultaneously. Firstly at step S8-1 the EN 34 transmits at regular intervals the current extended MAP option to access routers in its domain. This ensures that access routers in the domain of the EN 34 advertise the latest CMPM field to potential and existing MNs. A typical range of frequencies for the EN 34 to send the extended MAP option is once every 1 to 30 s, although it may be possible for the EN 34 to send the extended MAP option only when the CMPM field 94 has changed. Secondly the EN 34 starts a process at step S8-2 in which it awaits receipt of binding updates from MNs. If a binding update is received the EN 34 performs the functionality described in RFC 4140 i.e. it performs Duplicate Address Detection (DAD) and replies with an appropriate Binding Acknowledgement. Following that the process returns to step S8-2.

Thirdly the EN 34 starts a process in which it awaits receipt of a value representative of the congestion λ in the access network 14. This value may be received from the BB 36 or it may be calculated by the EN 34 itself, although it is assumed that in this embodiment the BB 36 is responsible for determining congestion λ at predetermined times. The routers in the access network use SNMPv2 (RFC 1905) to transmit information about their links to the BB 36. In particular, each router transmits data to the BB 36 that represents bandwidth utilisation on each of its network interfaces. This may be performed under SNMPv2 either using the request-response mode or using unsolicited trap messages sent by the routers to the BB 36. One way that bandwidth utilisation can be calculated for a network interface is described in the document “How to Calculate Bandwidth Utilization using SNMP” available from Cisco Systems, Inc. under document ID 8141 and also available from www.cisco.com/en/US/tech/tk648/tk362/technologies_tech_note09186a008009496e.shtml at the priority date hereof. That document is incorporated herein by reference for all purposes. The result of such as calculation is a percentage value of bandwidth usage on each link in the network at that point in time, such that λ can be expressed as a value between a maximum and minimum e.g. between 0 and 1. The BB 36 may collect all of the objects required to perform the calculation, or alternatively each router may determine bandwidth utilisation periodically and send a trap message to the BB 36.

When the BB 36 receives these objects, it may use the objects to determine an average bandwidth utilisation for the entire access network. Alternatively, the BB 36 may determine an average bandwidth utilisation for particular links in the network used by HMIPv6 tunnels to and from the EN 34. The choice of whether to monitor congestion in the entire access network, only in certain links of the access network, or a combination of the two is left to the network operator who configures the BB 36; this choice may be dependent on the network topology, capacity, etc.

Another alternative is for the BB 36 to monitor the number of flows it admits to the access network through the or each gateway (a flow may be defined as the number of bps delivered from a source to a destination). The number of flows and the bandwidth used by each can be used to determine congestion λ as defined above.

The BB 36 determines the current value of λ (between 0 and 1) every 1 s. When the value of λ changes the BB 36 sends the new value to the EN 34. Otherwise the BB 36 sends the current value of λ again after 5 minutes; this helps to reduce signalling overhead on the network. Accordingly at step S8-4 the EN 34 awaits receipt of data representative of congestion λ in the network (be it locally around the EN 34, of the entire network, or some combination of the two—although this is immaterial to the EN 34 that just processes the congestion value λ that it receives). When a value of λ is received, the EN 34 checks to see that the value is greater than zero at step S8-5. If λ=0 then EN 34 returns to step S8-4; λ may be zero even if there is some congestion in the network—in that case the congestion has not crossed a minimum threshold to trigger the EN 34 to restrict access to HMIPv6 for certain classes of traffic. The minimum threshold level may be set by the network operator at the point where the network transitions from being under utilised to over utilised (see description of FIG. 5).

At step S8-6 the EN 34 uses the most recent value of λ that is has received to calculate a value M as follows:

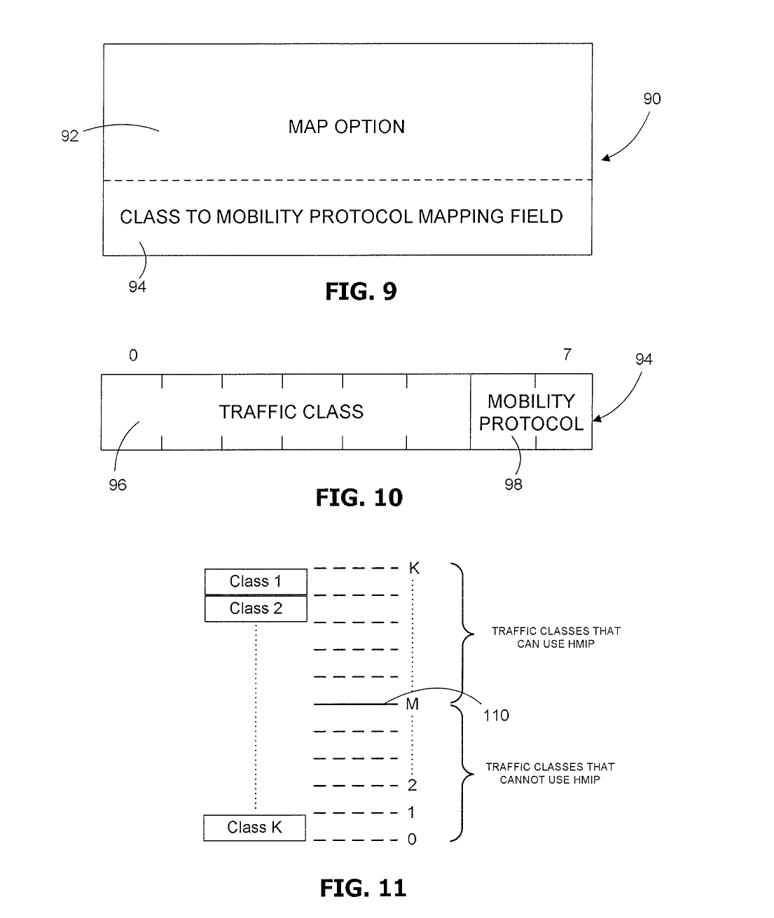

M=round(K*λ)

where K is the total number of classes of traffic that can be configured to use Mobile IP, and round( ) is a function that rounds up and down the value of the M to the nearest integer. M itself is a threshold value that divides those classes of traffic that can use HMIPv6 and those that must use Mobile IP. FIG. 11 shows how classes of traffic can be divided; in particular there are K classes to be assigned either to Mobile IP or to HMIPv6. Some of those K classes of traffic are delay sensitive (such as any real-time data e.g. VoIP, streaming) that benefit from HMIPv6; others of those K classes are relatively more delay tolerant (such as any non-real-time data e.g. Web browsing, ftp) that can be assigned either to HMIPv6 or to MIPv6. The classes are listed in increasing order of delay tolerance, so that class 1 represents the least delay tolerant traffic such as voice traffic for example. Since the congestion value λ varies between 0 and 1 (0 minimum congestion and 1 maximum congestion), the threshold M is caused to vary between 0 and K. In this way the current congestion level λ can be used to set a threshold level 110 between those classes of traffic that the EN 34 will accept to use HMIPv6 and those classes of traffic that the EN 34 will not accept, and therefore must use Mobile IP (or other mobility protocol).

One example of how traffic classes may be assigned is provided by the four UMTS QoS traffic classes: conversational, streaming, interactive and background. A useful summary of these classes is given in Table 2 of “Resource Management and Quality of Service in Third-Generation Wireless Networks”, Dixit, S. et al., page 125, IEEE Communications Magazine, February 2001 which is fully incorporated herein by reference for all purposes. If the access network 14 uses the same traffic classes as these UMTS QoS traffic classes, then K=4 and M varies in integer amounts between 0 and 4.

Referring again to FIG. 8 the EN 34 determines the value of Mat step S8-6 and at step S8-7 compares the new M value to the previous value stored in memory. If M has not changed (for example if λ has not changed sufficiently for the round( ) function to round M up or down) the EN 34 goes to step S8-1 and continues to send the current version of the extended MAP option that it has stored in memory. If M has changed however, the EN 34 goes to step S8-8 where a check is made that M is greater than zero, since the value may have changed from 1 to 0 at the last calculation. If M has changed to zero i.e. the level of congestion λ in the network as monitored by the BB 36 has dropped below a predetermined minimum threshold (which can be set by the network operator according to the particular network characteristics, business model, etc.), the EN 34 assigns all classes of traffic to HMIPv6 at step S8-9, and proceeds to step S8-11 described below.

If M remains greater than zero the EN 34 uses the threshold M to change the number of classes available for HMIPv6 at step S8-10 and to change the data used to create the CMPM field 94 at step S8-11 (recalling that at step S8-7 it was determined that M has changed). At step S8-12 the EN 34 creates and stores a new extended MAP option. At step S8-13 the EN 34 sends the new extended MAP option to access routers in its domain so that they advertise the latest CMPM field 94 to mobile nodes. Following that the EN 34 uses the new extended MAP option in step S8-1 to send into its domain periodically.

If the value of congestion increases above the minimum threshold set by the network operator, the value of λ begins to increase from 0. Since the threshold M is dependent both on congestion λ and the number of classes K, there is required only a small increase or decrease in λ in the network to change M by ±1 when there is a greater total number of classes K compared to when there is a smaller total number of classes. For example, if there are two traffic classes (i.e. K=2) congestion λ only needs to reach 0.25 from 0 before M switches to 1 and divides the two classes between MIP and HMIP. Once M has changed to 1 congestion λ must fall back to 0.24 before M changes to 0. This has the advantage that, if congestion becomes high e.g. λ=0.95, it has to reduce considerably before the other class of traffic is permitted to use HMIP again. For example, traffic of lower classes in the network (such as FTP etc.) can quickly take up space and cause high congestion which would otherwise result in degradation of the higher classes of traffic (such as VoIP etc.). Thus in this case the method is quick to restrict access to HMIP and slow to permit access again, such that the higher classes of traffic are protected. As K increases, the effect of the equation is to restrict and permit classes to HMIP increasingly more gradually.

When congestion λ is near a threshold where M changes from one value to another, it is possible that M might oscillate between one level and another. This would be undesirable. In order to inhibit this, the EN 34 may implement a mechanism whereby when M changes, it is not permitted to change again (either increase or decrease) within a predetermined period of time. Such a period of time may be determined by the network operator, and may be dependent on the particular characteristics of that network. Alternatively the operator might set a plus/minus threshold (e.g. λ±Δλ) relative to each congestion value λ where M changes. The threshold has to be crossed (in either direction) before the value of M is allowed to change again. This ensures that only if there is a considerable change in the state of congestion the value of M is allowed to be changed. It is also possible that the method of using a time threshold and a congestion value threshold can be used together in combination by the operator to deal with situations when network conditions change very frequently. There can be an OR logic between these two thresholds: whichever one is true first can set the trigger to allow the next change in M. Alternatively if it seems beneficial to the network operator, an AND operator can be used. This will greatly reduce the chance of oscillations by ensuring two thresholds have to be crossed before the value of M can be allowed to change.

The current value of M determines which classes the EN 34 will advertise for HMIPv6 to MNs.

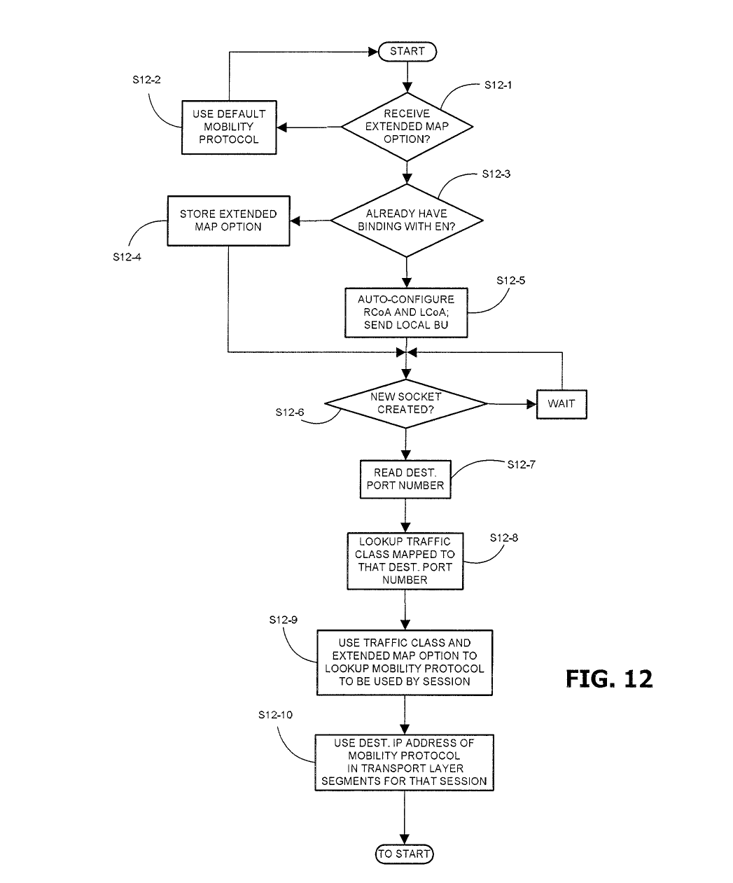

How the operation of the EN 34 is effected by receipt and processing of the extended MAP option will become apparent from the perspective of the MN 18 wishing to attach to the access network 14. Referring to FIG. 12 when the mobile node receives a router advertisement it checks whether or not it contains the extended MAP option (e.g. by looking for a flag that is set) at step S12-1. If none is received, the MN 18 continues to use its default mobility protocol at step S12-2, such as Mobile IP. Binding updates will need to be sent to the Home Agent and any correspondent nodes, assuming that it attaches to the network. When an extended MAP option is received the MN 18 checks whether or not it already has a binding with the EN 34 at step S12-3. If so, the MN 18 stores the latest extended MAP option in memory at step S12-4 and proceeds to step S12-6 described in greater detail below. If the MN 18 does not have a binding with the EN 34, it auto-configures an RCoA and LCoA, and sends a local binding update to the EN 34 at step S12-5. The EN 34 replies with a Binding Acknowledgement indicating that the binding was successful or indicating an appropriate fault code. At this stage the MN 18 has not initiated any sessions that require the services of the EN 34 or the access network 14.

At step S12-6 the MN 18 waits for a socket to be opened by a process, such as a process used by web-browsing application or by a VoIP call for example. If no socket is opened the MN 18 waits. When a socket is opened, the MN 18 reads the destination port number to be used in transport layer segments (e.g. TCP or UDP) at step S12-7. The destination port number is used by the MN 18 to lookup a corresponding traffic class at step S12-8. For example, data on port 80 (i.e. HTTP) may map to the interactive traffic class of the UMTS QoS classes. An example of this mapping is shown in columns 1 and 2 of Table 1 below.

TABLE 1

| Best. | | | Example Data | |
|---|---|---|---|---|
| Port(s) | UMTS Traffic | Mobility | Type - Example | |
| CTCP/UDP) | Class & No. | Protocol | Application | Type |
| TCP: 5000- | Conversational - 1 | HMIPv6 | Voice - Yahoo | Real |
| 5001/UDP: | | | Messenger Voice | Time |
| 5000-5010 | | | Chat | |
| TCP: | Streaming - 2 | HMIPv6 | Video/Audio | Real |
| 7070/UDP: | | | Streaming - Real | Time |
| 6970-7170 | | | Audio and Video | |
| TCP: 80 | Interactive - 3 | MIPv6 | Web browsing - | Best |
| | | | Mozilla Firefox | Effort |
| TCP: 110 | Background - 4 | MIPv6 | Emails - POP3 | Best |
| | | | | Effort |

In order to achieve this the MN 18 is pre-configured to map certain port numbers to certain traffic classes. The details of which types of application must use certain port numbers may be decided by network operators and provided to application developers. The application developers can then ensure that applications use the correct port numbers to send packet traffic. It is expected that, depending on the number of traffic classes, a number of destination port numbers would map to one traffic class. It is recommended that the destination port numbers used by processes on the MNs follow the IANA standard port numbers (see www.iana.org/assignments/port-numbers), although this is not essential.

The fourth column (‘Mobility Protocol’) of Table 1 reflects the latest M value that has been determined by the EN 34. In the example of Table 1 shown, M=3 such that any traffic classes with traffic class number of M≦3 are assigned to Mobile IPv6, whereas the more delay sensitive traffic classes are assigned to HMIPv6.

Once the traffic class has been determined the MN 18 uses at step S12-9 the latest CMPM field 94 that it has received to check which mobility protocol is presently assigned to that class by the EN 34. In the example shown in Table 1, web-browsing traffic is assigned to Mobile IPv6 due to congestion in the network. At step S12-10 the MN 18 uses that mobility protocol to send packet data over the access network 14. The indication provided by the CMPM field 94 will change the destination IP address of the tunnel endpoint at the network layer for datagrams of that session. Assuming that the two mobility protocol options are either Mobile IP or HMIPv6, IP packets will be tunnelled in IP packets address either to the Home Agent (if Mobile IP) or to the EN 34 (if HMIPv6). In this way the EN 34 can control which classes of traffic are routed through the EN 34. Those IP packets sent using a mobility protocol other than HMIPv6 are routed around the EN 34, thereby making use of under-utilised paths.

Packets sent by the MN 18 to the access network 14 are received by the access router 20 that comprises a classifier and marker. The classifier selects packets based on the values of one or more packet header fields (for example, source address, destination address, source port, destination port, and protocol ID) and steers the packet to the appropriate marking function. The DiffServ field is then set appropriately by the marker. The DSCP used should reflect the UMTS QoS classes mentioned above to ensure that the packet receives the appropriate per hop behaviour in the access network 14. For example the traffic classes could be marked as shown in Table 2 below:

TABLE 2

| UMTS Traffic | DSCP (bit pattern in |
|---|---|
| Class & No. | CMPM field) |
| Conversational - 1 | 001010 |
| Streaming - 2 | 010010 |
| Interactive - 3 | 011010 |
| Background - 4 | 100010 |

After step S12-10 the MN 18 returns to the start. Receipt of further extended MAP options causes the MN 18 to update the version it stores in memory. Alternatively, each extended MAP option may have a lifetime and the MN 18 may apply the CMPM field 94 of that option for the lifetime. However, it is preferred that the MN 18 use the most recent version of the extended MAP option that it has received from the access network 14 when opening any socket. In this way, it is possible for one mobile node to have, for example, a first web-browsing session through HMIPv6 and a second web-browsing session routed with another mobility protocol such as Mobile IP. The first session was started when the EN 34 accepted web traffic; however, as a result of increased congestion in the access network as advised by the BB 36, the EN 34 adjusted the threshold M. This caused a new CMPM field to be advertised in the extended MAP option whereby when the second web-browsing session was started, mobility was supported by a Mobile IP tunnel instead. In this way the EN 34 diverted traffic flows through other less congested routers in the access network 14 at the appropriate time. If congestion subsides the EN 34 may allow web-traffic to use HMIPv6 again.

The operating system of the MN 18 should be adjusted to recognise the extended MAP option and to operate according to the steps shown in FIG. 12. Such configuration may be made either at point of manufacture or via an OTA update. If any mobile nodes are not configured to process the extended MAP option, but are still HMIP-aware, they will not be able to send/receive packets to/from the EN 34 as the EN 34 will drop any packet with a DSCP that falls in one the traffic classes that is assigned to another mobility protocol at that time.

FIG. 8A shows a signalling diagram illustrating the MN 18 attaching to the access network 14. FIG. 8B is a signalling diagram of the signals send following a change in the threshold M.

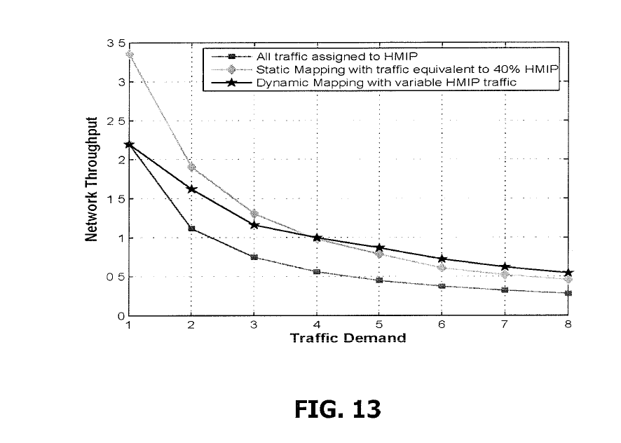

FIG. 13 is a graph generated using the network simulation described above and shows traffic demand versus network throughput in three scenarios (1) dynamic mapping of traffic classes to mobility protocols; (2) a static mapping i.e. a fixed split between Mobile IP and HMIPv6 that is independent of the congestion in the network; and (3) no mapping where 100% of the traffic uses HMIPv6. The simulation assumed two ENs (at nodes 10 and 12 in FIG. 4). Recalling that for any network throughput greater than 1 the access network is under-utilised, there is no benefit gained by either dynamic or static mapping until the traffic demand reaches 4 since the network meets all demand below that. It can be seen that as traffic demand increases beyond 4 and the network becomes over-utilised, both dynamic mapping and static mapping offer improve throughput compared to scenario (3) when all traffic is assigned to HMIPv6. In both dynamic and static mapping delay tolerant QoS classes utilise another mobility protocol(s) so that traffic in those classes is routed around the Enhanced Nodes. This reduces the congestion around the Enhanced Nodes, resulting in increased throughput. Furthermore by dynamically adjusting the traffic classes that can use HMIP as a function of congestion in the access network greater improvements in network throughput can be achieved when the network is over-loaded.

Other alternative equations for determining M are envisaged. What is important about such equations is that M is proportional (linearly or non-linearly) to congestion λ and the number of classes K. An example of an alternative equation is:

M=round(e^{αKλ})

where α is set in such a way to ensure that M is always between [0, K]. Such a function will make M highly sensitive to high values of congestion λ.

The MN 18 may be a hand-held mobile terminal such as a phone, PDA, digital media player or notebook computer for example. The mobile node may also be a mobile router for example.

It will be appreciated that the invention is applicable to all current and future varieties of micro mobility protocols (current varieties include HMIP, PMIP and BCMP) that utilise mobility agents or anything functionally similar that causes packet congestion in the network by constraining choice of routes through the network.

There may be more than one Enhanced Node in the access network, and of those Enhanced Nodes one or more may function according to the method of the invention. The calculation of the threshold value M may be performed at an Enhanced Node, at a Bandwidth Broker or by any other logical entity or at any other network node in the access network.

Although the embodiments of the invention described with reference to the drawings comprises computer apparatus and methods performed in computer apparatus, the invention also extends to computer programs, particularly computer programs on or in a carrier, adapted for putting the invention into practice. The program may be in the form of source code, object code, a code intermediate source and object code such as in partially compiled form, or in any other form suitable for use in the implementation of the methods according to the invention. The carrier may be any entity or device capable of carrying the program. For example, the carrier may comprise a storage medium, such as a ROM, for example a CD ROM or a semiconductor ROM, or a magnetic recording medium, for example a floppy disc or hard disk. Further, the carrier may be a transmissible carrier such as an electrical or optical signal that may be conveyed via electrical or optical cable or by radio or other means.

When the program is embodied in a signal that may be conveyed directly by a cable or other device or means, the carrier may be constituted by such cable or other device or means. Alternatively, the carrier may be an integrated circuit in which the program is embedded, the integrated circuit being adapted for performing, or for use in the performance of the relevant methods.

While the invention has been disclosed in connection with certain preferred embodiments, this should not be taken as a limitation to all of the provided details. Modifications and variations of the described embodiments may be made without departing from the spirit and scope of the invention, and other embodiments should be understood to be encompassed in the present disclosure as would be understood by those of ordinary skill in the art.

1. In a packet-switched access network using a tunnelling-type micro-mobility protocol whereby packets are caused to flow through at least one mobility agent located in said access network, a method of reducing congestion at and/or in routers near said mobility agent, which method comprises:
causing packet traffic of a first traffic class to use said tunnelling-type micro mobility protocol, and
causing packet traffic of a second traffic class to use another mobility protocol, whereby packet traffic of said second traffic class is routed across said access network away from said mobility agent.

2. The method of claim 1 further comprising: said access network advertising to mobile nodes which class of packet traffic may use which mobility protocol.

3. The method of claim 2 further comprising: advertising to mobile nodes a static and/or dynamic mapping between traffic class and mobility protocol.

4. The method of claim 3 wherein said dynamic mapping comprises the step of changing which traffic class is mapped to which mobility protocol.

5. The method of claim 3 further comprising:
monitoring packet congestion within said access network; and
changing said dynamic mapping between traffic class and mobility protocol according to said packet congestion.

6. The method of claim 5 further comprising:
expressing said packet congestion as a value on a scale between minimum and maximum values; and
using said value to adjust a traffic class threshold for setting which traffic classes use said tunnelling-type mobility protocol, which traffic class(es) use one or more other mobility protocol.

7. The method of claim 5 further comprising: using a Bandwidth Broker and/or said mobility agent to monitor said packet congestion.

8. The method of claim 3 further comprising:
as congestion increases in said access network, reducing the number of traffic classes that can use said mobility agent;
whereby said mobile nodes are caused to use another mobility protocol to send and receive packet data for an increased number of traffic classes.

9. The method of claim 8 wherein the step of reducing the number of traffic classes comprises assigning relatively delay tolerant traffic classes to said other mobility protocol, whereby relatively less delay tolerant traffic class(es) remain in said reduced number of traffic classes able to use said tunnelling-type mobility protocol.

10. The method of claim 8 further comprising: advertising to said mobile nodes which other mobility protocol(s) is available for said packet data of said increased number of traffic classes.

11. The method of claim 8 further comprising:
as congestion decreases in said access network, increasing the number of traffic classes that can use said mobility agent;
whereby said mobile nodes are caused to use another mobility protocol to send and receive packet data for a decreased number of traffic classes.

12. The method of claim 11 further comprising: advertising to said mobile nodes which other mobility protocol(s) is available for said packet data of said decreased number of traffic classes.

13. The method of claim 2 wherein said advertising step comprises using a field in an advertisement message, receipt of said field indicating to each mobile node which mobility protocol is available for which class of traffic.

14. The method of claim 13 wherein said field comprises bits for representing an identity of a traffic class, and bits for representing an identity of a mobility protocol to be used by a mobile node sending packet data in said traffic class.

15. The method of claim 13 wherein said field is part of an MAP option message to form an extended MAP option, the method further comprising the steps of said access network composing and advertising said extended MAP option to mobile nodes.

16. A method of operating a mobile node for accessing a packet-switched wireless access network, said mobile node capable of sending packet data of a plurality of different traffic classes across said access network, which method comprises:
determining which traffic class is associated with an application intending to send packets across said access network; and
depending on said traffic class as determined, using either a tunnelling-type mobility protocol or another mobility protocol to send said packets to said access network.

17. The method of claim 16 further comprising:
using said mapping to determine said traffic class for said application; and
wherein said mobile node stores a direct or indirect mapping between application types and traffic classes.

18. The method of claim 17 wherein said mapping is static.

19. The method of claim 17 wherein said mapping is dynamic.

20. The method of claim 18 further comprising:
receiving an advertisement message from said access network;
examining said advertisement message to determine if it comprises an adjustment to said mapping; and
if said advertisement message is determined to comprise an adjustment, adjusting said mapping.

21. The method of claim 19 wherein said advertisement message comprises a field having bits for representing an identity of a traffic class, and bits for representing an identity of a mobility protocol to be used by said mobile node when sending packet data in that traffic class, wherein said adjustment step comprises storing said field in memory.

22. A packet-switched wireless access network comprising at least one mobility agent and a plurality of routers, which access network uses a tunnelling-type micro-mobility protocol, whereby packets are caused to flow through said at least one mobility agent, and wherein said packet-switched access network is configured to reduce congestion at and/or in routers near said mobility agent, by causing packet traffic of a first traffic class to use said tunnelling-type micro mobility protocol and packet traffic of a second traffic class to use another mobility protocol, whereby packet traffic of said second traffic class is routed across said access network away from said mobility agent.

23. A mobile node comprising a computer-readable memory storing computer executable instructions for operating the mobile node, which memory comprises
computer-executable instructions for causing said mobile node to send packet data of a plurality of different traffic classes across said access network;
computer-executable instructions for causing said mobile node to determine which traffic class is associated with an application intending to send packets across said access network; and
depending on said traffic class as determined, computer-executable instructions for using either a tunnelling-type mobility protocol or another mobility protocol to send said packets to said access network.

24. A tunnelling type micro-mobility protocol message comprising a field for identifying a traffic class mapped to a field for identifying a mobility protocol, receipt of said message causing network nodes to send packet data falling in said traffic class using said mobility protocol.

25. A message as claimed in claim 23, further comprising a plurality of said fields, whereby said message identifies which mobility protocol is to be used by said network nodes for packet data falling in any class of traffic that any network node may send.
